(19) United States
(12) Patent Application Publication
(10) Pub. No.: US 2014/0166427 A1
(43) Pub. Date: Jun. 19, 2014

(54) CLUTCH SEPARATOR PLATE

(71) Applicants: Albert J. Youngwerth, Boise, ID (US); Sean G. Brown, Boise, ID (US); Karl E. Jensen, Meridian, ID (US); Logan P. Krueger, Boise, ID (US)

(72) Inventors: Albert J. Youngwerth, Boise, ID (US); Sean G. Brown, Boise, ID (US); Karl E. Jensen, Meridian, ID (US); Logan P. Krueger, Boise, ID (US)

(73) Assignee: REKLUSE MOTOR SPORTS, Boise, ID (US)

(21) Appl. No.: 14/132,055

(22) Filed: Dec. 18, 2013

Related U.S. Application Data
(60) Provisional application No. 61/738,512, filed on Dec. 18, 2012.

(51) Int. Cl. F16D 13/70

(52) U.S. Cl. CPC F16D 13/70
USPC 192/109 R

(57) ABSTRACT

A novel clutch separator plate is disclosed. The improved clutch separator plate incorporates openings which pass over the friction pads of a friction plate to improved thermal stability, reduce drag and provide consistent and positive engagement.

### CROSS REFERENCE TO RELATED APPLICATIONS

This application claims priority to provisional application 61/738,512.

### BACKGROUND OF THE INVENTION

This invention relates to a clutch system of the friction type placed in a power transmission system. Typical clutch systems include a clutch basket rotationally coupled to a clutch input, a center clutch rotationally coupled to a clutch output, and one or more plates making up a clutch pack disposed between the clutch basket and center clutch. When the clutch pack is compressed, the clutch input and clutch output become rotationally coupled. The clutch pack is typically compressed by a pressure plate; the pressure plate typically providing a compressive force via a spring mechanism or through a centrifugally actuated mechanism.

Clutch packs are typically comprised of a plurality of two types of plates, friction plates and separator plates, where the separator plates are interleaved between the friction plates. In general, friction plates are coupled to the clutch input and separator plates are coupled to the clutch output, but in some cases, friction plates can be coupled to the clutch output and separator plates can be coupled to the clutch input.

Friction plates typically have friction material affixed to either side with the friction material arranged symmetrically around the friction plate maintaining a relative concentricity with the friction plate. The friction material typically maintains a consistent working inner diameter and working outer diameter placing the friction material in direct contact with the opposing surface of a separator plate.

In general, separator plates are round discs in structure and are designed to have a continuous and constant engaged surface for the friction material of the friction plate to contact. Typically, the engaged surface of the separator plate is defined by the annulus created by the working outer diameter and working inner diameter of the friction material so that the separator plate fully supports the inner and outer working boundaries of the friction material.

Typically, such clutch systems include a clutch disengagement system consisting of a lever mechanically coupled to the pressure plate such that when the lever is actuated, the pressure plate's compressive force on the clutch pack is removed, disconnecting the rotational coupling between the clutch input and clutch output. Clutch disengagement systems typically couple the lever to the pressure plate mechanically through a hydraulic actuation system or a cable actuation system.

Most motorcycles incorporate a manual transmission coupled to the engine via a multi-plate clutch assembly. Typically, the multi-plate clutch operates in a wet environment where oil is used to help cool the clutch and provide lubricity in order to maintain consistent frictional performance. Typically, the multi-plate clutch is engaged/disengaged by the driver via a lever mounted on the handlebar. Although the lever operated clutch allows the driver to control the clutch engagement/disengagement, motorcycle drivers may find the clutch lever difficult to operate smoothly. Some of the difficulty associated with operating a clutch lever comes from changes in temperature causing thermal expansion and contraction of the clutch pack directly affecting the modulation point and lever modulation range.

The modulation point is the lever position such that the clutch is disengaged when pulling the lever in from its resting position, or conversely where the clutch begins to re-engage when letting the lever out after the lever has been pulled in past the modulation point.

The lever modulation range is the effective total distance the lever must be moved between the initiation point and lever modulation point.

The initiation point corresponds to the lever position such that the pressure plate begins to move and the compressive force from the pressure plate begins to be removed from the clutch pack and thus clutch disengagement begins. Conversely, the initiation point corresponds to the lever position where the clutch fully re-engages when releasing the lever after it has been pulled in past the initiation point, modulation point, or some position between the initiation point and modulation point.

Motorcycle riders have difficulty adjusting to changes in the lever modulation point and lever modulation range while applying the throttle and releasing the lever to engage the clutch and move the vehicle from a standing start. There are other situations where having to adapt to changes in the modulation point and lever modulation range makes controlling the clutch engagement or disengagement more difficult. Experienced motorcycle riders may need to partially disengage the clutch when traveling slowly to allow the engine to continue running without stalling. Motorcycle racers often have a difficult time controlling the engagement of the clutch while applying the throttle to maximize acceleration.

Beyond clutch pack expansion and contraction due to temperature changes, the modulation point and lever modulation range can be affected by clutch drag that exists between adjacent faces of a friction plate and separator plate when both are rotationally coupled. Specifically, in a wet clutch, an oil film exists between the friction material and engaged surface of an adjacent separator plate. As the lever is actuated through the lever modulation range, pressure is reduced in the clutch pack lowering the coupling force between the friction material and engaged surface. Once the lever is pulled in to the lever modulation point, the oil film between the friction material and engaged surface must be sheared to de-couple the friction plate and separator plate. The surface tension of the oil is the oils ability to resist shearing under this condition and is affected by an oils construction and the oils temperature. The force required to shear the oil film can retard the engagement of the clutch and add undesirable drag to the clutch system; further hindering the feeling of the modulation point and making the clutch more difficult to control for the rider.

Therefore a need exists for a separator plate that can dissipate more heat to aid in maintaining thermal stability of a clutch pack and improve the shearing of the oil film between the friction and separator plates to reduce clutch drag and improve the feeling of the modulation point.

It is therefore an object of the present invention to provide a separator plate design that improves thermal stability, reduces the effect of the oil film's surface tension and improve the stability of the modulation point and allow the modulation range to remain consistent.

The present invention for typical multi-plate clutch is disclosed in FIGS. 1 through 5.

### BRIEF DESCRIPTION OF THE DRAWINGS

FIG. 1 is a view of a friction plate and separator plate.

FIG. 2 is an isometric section view of a clutch pack.

FIG. 3 shows the working annular area of contact between a friction plate and separator plate with inner and outer diameters denoted.

FIG. 4 shows a standard separator plate

FIG. 5 is of the preferred embodiment of a separator plate.

### DETAILED DESCRIPTION OF THE INVENTION

Reference throughout this specification to “an embodiment,” or similar language means that a particular feature, structure, or characteristic described in connection with the embodiment is included in at least one embodiment of the present invention. Thus, appearances of the phrases “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of the embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Multi-plate clutch systems are well known in the art and are typified by systems included on motorcycles such as those provided by Honda such as the Honda model year 2008 CRF450R.

A typical multi-plate clutch system includes a clutch basket, a center clutch, a clutch pack, a pressure plate, a compressive force mechanism, a disengagement mechanism, and a clutch lever.

The typical multi-plate clutch is configured with the clutch basket being rotationally coupled to a clutch input, the center clutch being rotationally coupled to a clutch output, the clutch pack disposed between the clutch basket, center clutch and pressure plate where the compressive force mechanism acts on the pressure plate and the disengagement mechanism is disposed between the clutch lever and pressure plate. The center clutch and clutch basket are positioned concentrically about the same center.

When the clutch pack is compressed, the clutch input and clutch output become rotationally coupled placing the multi-plate clutch in an engaged state. When the clutch is not compressed, the clutch input and clutch output are not rotationally coupled placing the multi-plate clutch in a disengaged state. The clutch pack is compressed by the pressure plate; the pressure plate being acted on by the compressive force mechanism. The disengagement mechanism, being disposed between the clutch lever and pressure plate, provides movement of the pressure plate when the clutch lever is actuated. In one direction, clutch lever actuation counter acts the compressive force mechanism and moves the pressure plate away from the clutch pack placing the multi-plate clutch in the disengaged state. When releasing the lever the pressure plate returns towards the clutch pack allowing the compressive force mechanism to compress the clutch pack through the pressure plate, placing the multi-plate clutch in the engaged state.

The clutch pack typically consists of a plurality of friction plates and separator plates which are interleaved resulting in a separator plate between each friction plate. The friction plates contain features which rotationally couple the friction plates to the clutch basket. The separator plates contain features which couple the separator plates rotationally to the center clutch.

Friction plates typically have friction material affixed to either side with the friction material arranged symmetrically around the friction plate maintaining a relative concentricity with the friction plate. The friction material typically maintains a consistent working inner diameter and working outer diameter placing the friction material in direct contact with the opposing surface of a separator plate.

In general, separator plates are round discs in structure and are designed to have a continuous and constant engaged surface for the friction material of the friction plate to contact. Typically, the engaged surface of the separator plate is defined by the annulus created by the working outer diameter and working inner diameter of the friction material so that the separator plate fully supports the inner and outer working boundaries of the friction material.

When the clutch lever is actuated in a manner to transition the multi-plate clutch from the engaged state to the disengaged state, there is an amount of clutch lever movement required called lever modulation range. The lever modulation range is defined by two points, the initiation point and modulation point.

In the disengaging direction, the initiation point corresponds to the clutch lever position where the pressure plate first begins to move and any further clutch lever movement further reduces the net compressive force imposed on the clutch pack via the compressive force mechanism. Conversely, the initiation point corresponds to the clutch lever position where the multi-plate clutch fully engages when releasing the clutch lever after it has been actuated past the initiation point, modulation point, or some position between the initiation point and modulation point.

The modulation point is the clutch lever position where the multi-plate clutch disengages completely when actuating the clutch lever in the disengaging direction. Conversely, the modulation point corresponds to the clutch lever position where the multi-plate clutch begins to re-engage when releasing the clutch lever after the clutch lever has been actuated in the disengaging direction past the modulation point.

The modulation point shifts with changes in temperature caused by thermal expansion and contraction of the clutch pack thus shifting the lever modulation range.

In addition to thermal induced shifting of the modulation point, the modulation point and lever modulation range can be affected by surface tension of the oil film that exists between adjacent faces of a friction plate and separator plate when both are rotationally coupled. Specifically, the oil film exists between the friction material and engaged surface of the adjacent separator plate. As the clutch lever is actuated through the lever modulation range, pressure is reduced in the clutch pack lowering the coupling force between the friction material and engaged surface. Once the clutch lever is pulled in to the modulation point the oil film between the friction material and engaged surface must be sheared to de-couple the friction plates and separator plates. The surface tension of the oil is the oils ability to resist shearing under this condition and is affected by an oils construction and the oils temperature. The force required to shear the oil film can add undesirable drag to the clutch system further increasing the lever modulation range and obscuring the modulation point.

The present invention provides for a novel separator plate providing improved thermal stability for a multi-plate clutch system while reducing undesirable drag resulting in improved clutch lever control of the disengagement and engagement of a multi-plate clutch. Multiple embodiments are disclosed for separator plates to be used in a multi-plate clutch system.

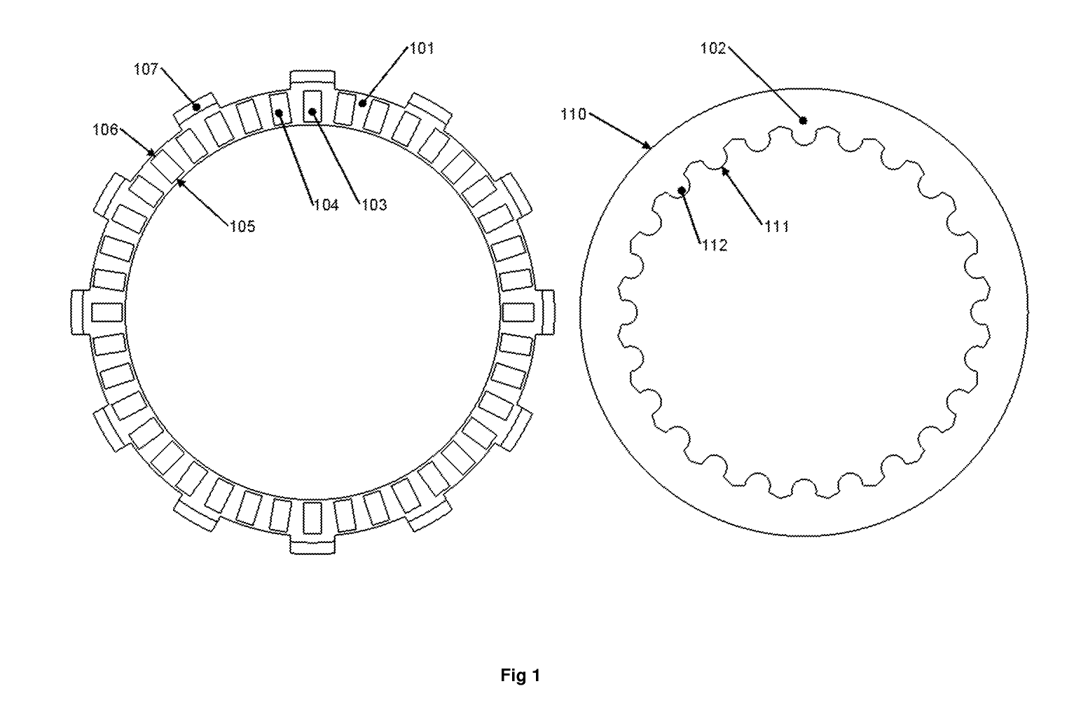

FIG. 1 discloses a typical prior art friction plate 101 and separator plate 102 from a multi-plate clutch. The friction plate 101 has a plurality of outer tabs 107. The friction plate 101 has friction material 103 configured as a plurality of pads 104 arranged symmetrically around the friction plate 101 equidistant from the center of the friction plate 101 creating a friction inner boundary 105 and friction outer boundary 106. The standard separator plate 102 is defined by the circular outer edge 110 and internal profile 111 where the internal profile 111 contains a plurality of indexing teeth 112.

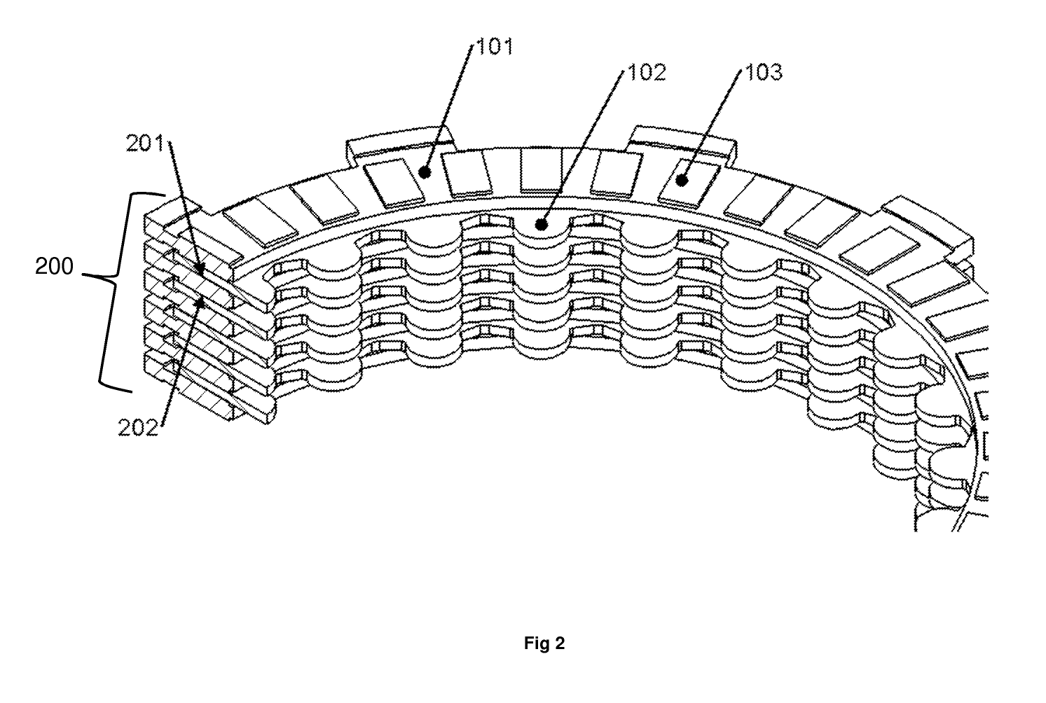

FIG. 2 represents a clutch pack 200 from a multi-plate clutch. The clutch pack 200 being comprised of multiple friction plates 101 and standard separator plates 102 arranged in alternating fashion as typified by the prior art. FIG. 2 shows the friction plates 101 and standard separator plates 102 stacked in alternating fashion with standard separator plates 102 positioned between each friction plate 101. As typified by the prior art, the friction plates 101 are concentrically aligned with the separator plates 102. In addition, the friction plates 101 have friction material 103 arranged on both sides signified by side one 201 and side two 202. Side one 201 and side two 202 illustrate the contact between a friction plate 101 and adjacent separator plates 102 stacked on either side of a friction plate 101.

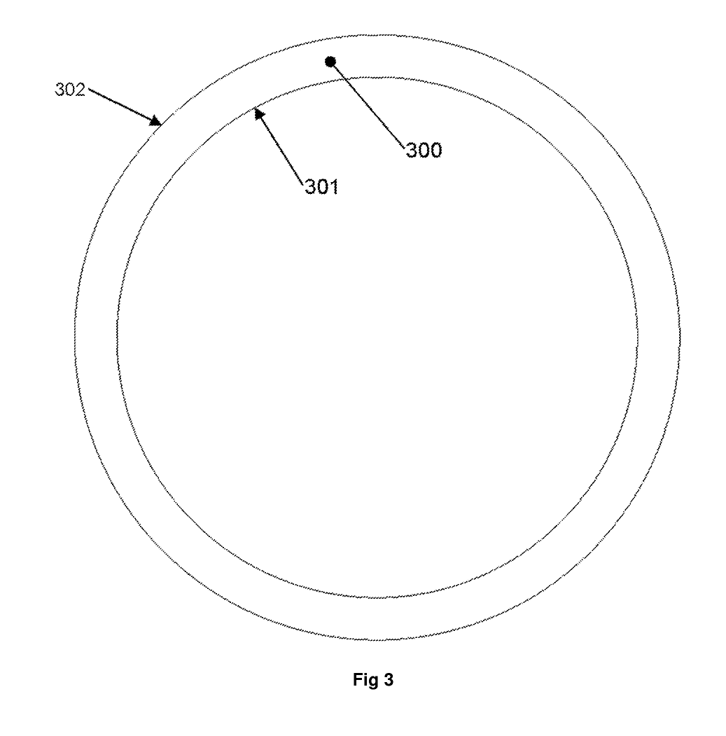

FIG. 3 discloses the working annulus 300. The working annulus 300 has an inner diameter 301 and outer diameter 302. The inner diameter 301 is defined by the working diameter of a circle tangent to the friction inner boundary 105 and concentric to the friction plate 101. The outer diameter 302 is defined by the working diameter of a circle tangent to the friction outer boundary 106 and concentric to the friction plate 101. The working annulus 300 represents the area where contact between a friction plate 101 and an adjacent separator plate 102 can take place.

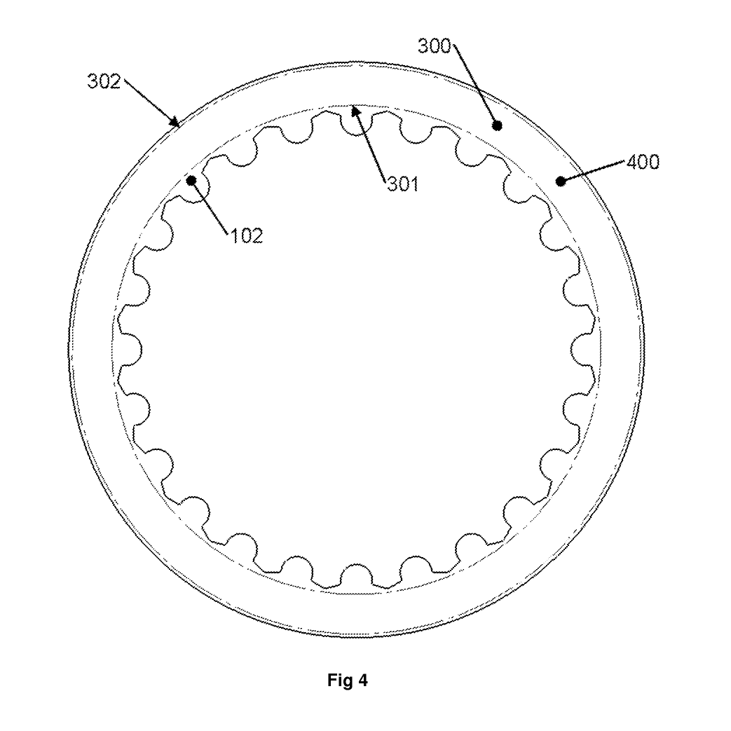

FIG. 4 depicts the standard separator plate 102 with inner diameter 301 and outer diameter 302 of the working annulus 300 projected onto the standard separator plate 102. FIG. 4 also shows the standard engaged area 400 of the standard separator plate 102. The standard engaged area 400 is defined by the available area of the standard separator plate 102 within the working annulus 300 and thus in contact with the friction plate 101 when arranged in a multi-plate clutch.

FIG. 4 shows the standard engaged area 400, of the standard separator plate 102, is equal to the area within the working annulus 300.

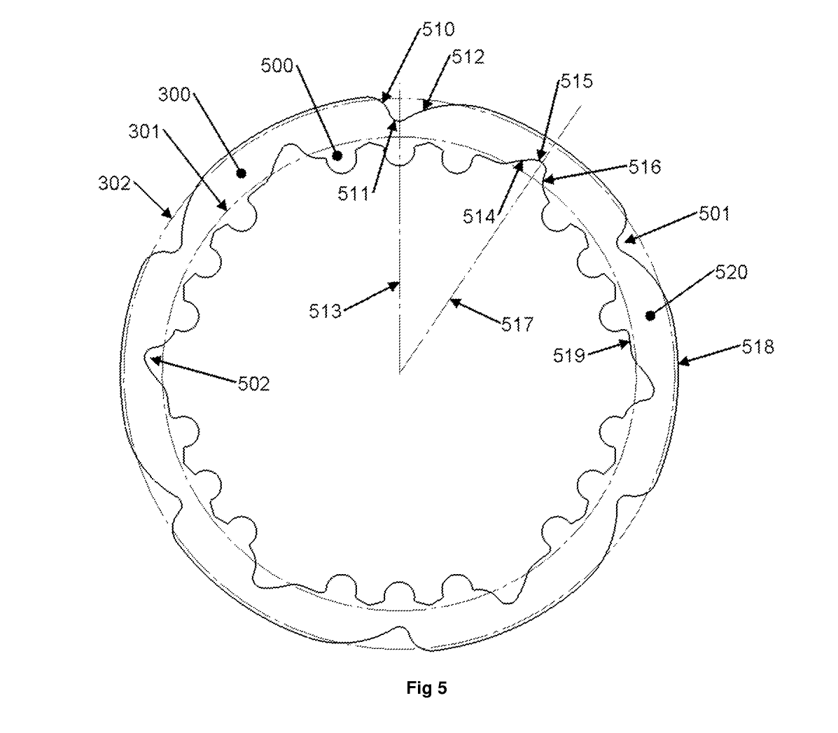

FIG. 5 discloses a preferred embodiment of the novel separator plate 500 with the inner diameter 301 and outer diameter 302 of the working annulus 300 projected onto the separator plate 500. FIG. 5 also shows the wavy engaged area 520 of the separator plate 500. The wavy engaged area 520 is defined by the available area of the separator plate 500 within the working annulus 300 and thus in contact with the friction plate 101 when arranged in a multi-plate clutch.

In addition, FIG. 5 discloses an external opening 501 interrupting the outer diameter of the annulus 302 and providing an opening of the separator plate 500 within the area defined by the working annulus 300 shown projected on the separator plate 500. FIG. 5 also shows an internal opening 502 providing an opening of the separator plate 500 within the area defined by the working annulus 300 shown projected on the separator plate 500.

FIG. 5 shows the external opening 501 is defined by a leading edge 510, a transition 511 and trailing edge 512 where the leading edge 510 and trailing edge 512 are asymmetric and are of non-equal edge lengths with respect to center line 513. The internal opening 502 is defined by an internal leading edge 514, internal transition 515, and internal trailing edge 516 where the internal leading edge 514 and internal trailing edge 516 are asymmetric and non-equal edge lengths with respect to second center line 517.

As depicted in FIG. 5, leading edge 510 forms a curve which transitions from and is tangent to the outer edge 518 and connects and is tangent to the transition 511. The transition 511 forms a curve which transitions from and is tangent to the leading edge 510 and connects and is tangent to the trailing edge 512. The trailing edge 512 forms a curve which transitions from and is tangent to the transition 511 and connects to and is tangent to the outer edge 518. Similarly, internal leading edge 514 forms a curve which transitions from and is tangent to the internal profile 519 and connects and is tangent to the internal transition 515. The internal transition 515 forms a curve which transitions from and is tangent to the internal leading edge 514 and connects and is tangent to the internal trailing edge 516. The internal trailing edge 516 forms a curve which transitions from and is tangent to the internal transition 515 and connects and is tangent to the internal profile 519.

In another embodiment leading edge 510 and trailing edge 512 are mirrored and symmetric with respect to center line 513. In another embodiment internal leading edge 514 and internal trailing edge 516 are mirrored and symmetric with respect to second center line 517.

The separator plate 500 disclosed in FIG. 5 shows six external openings 501 and six internal openings 502 arranged in alternating fashion distributed evenly around separator plate 500 maintaining symmetry relative to the working annulus 300 and centroid of the separator plate 500. In another embodiment separator plate 500 has fewer external openings and fewer internal openings. In another embodiment separator plate 500 has external openings 501 and no internal openings 502. In another embodiment separator plate 500 has internal openings 502 and no external openings 501. In another embodiment the external opening 501 is smaller in size with differently shaped leading edge 510, transition 511 and trailing edge 512.

In testing, the preferred embodiment of the separator plate 500 has increased thermal stability and reduced clutch drag when compared to the standard separator plate 102. The wavy engaged area 520 of the separator plate 500 is reduced from the engaged area 400 of the standard separator plate 102 depicted in FIG. 4. The reduced area engaged between adjacent surfaces of the separator plate 500 and friction plate 101 lowers the drag due to oil film surface tension and provides a narrower modulation range when compared to a similar multi-plate clutch utilizing standard separator plates 102. Furthermore, as the clutch is engaging the external opening 501 and internal opening 502 help to shear oil off of the friction pads 104 lowering drag and providing for a narrower modulation range.

The present invention may be embodied in other specific forms without departing from its spirit or essential characteristics. For example, for one skilled in the art, the present invention could be adapted for use in other types of vehicles that use clutch disengagement systems. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a clutch system including a friction plate, said friction plate including a friction pad area, said friction pad area having an annulus defined by the inner boundary and outer boundary of said friction pad area, the improvement comprising: a clutch separator plate, said clutch separator plate in concentric relation to said friction plate and wherein said clutch separator plate includes an outer boundary, an inner boundary and a plurality of openings, said outer boundary and said inner boundary encompassing said annulus and said openings being within said annulus.

2. The clutch separator plate of claim 1 wherein said openings protrude from said outer boundary.

3. The clutch separator plate of claim 1 wherein said openings protrude from said inner boundary.

4. The clutch separator plate of claim 1 wherein said openings protrude from said inner boundary and said outer boundary.

5. The clutch separator plate of claim 1 wherein said opening includes a leading edge, a transition and a trailing edge.

6. The clutch separator plate of claim 5 wherein said leading edge length is not equal to said trailing edge length.
